(19) United States
(12) Patent Application Publication
(10) Pub. No.: US 2016/0310776 A1
(43) Pub. Date: Oct. 27, 2016

(54) Systems And Methods For Isometric Exercise Training Within An Infrared Sauna

(71) Applicant: Planet Beach Brands, LLC, Marrero, LA (US)

(72) Inventor: Stephen Paul Smith, Marrero, LA (US)

(73) Assignee: Planet Beach Brands, LLC, Marrero, LA (US)

(21) Appl. No.: 14/984,927

(22) Filed: Dec. 30, 2015

Related U.S. Application Data
(60) Provisional application No. 62/151,023, filed on Apr. 22, 2015.

(51) Int. Cl. A63B 21/002; A61H 33/06

(52) U.S. Cl. CPC A63B 21/0023; A61H 33/06; A61H 2033/061

(57) ABSTRACT

The present invention is generally related to isometric exercise training within an infrared sauna, and the like, and more particularly related to several methods for isometric exercise training within an infrared sauna system and several infrared sauna systems specifically designed for use by one or more users performing, or being directed to perform, a sequence of isometric poses, thereby causing the users to receive the wellness benefits of both far infrared rays and isometric exercise training.

### CROSS-REFERENCES TO RELATED APPLICATIONS

This non-provisional application takes priority to the previously filed provisional application: Application No. 62/151,023, filed 22 Apr. 2015, which is hereby incorporated in its entirety by reference.

### BRIEF DESCRIPTION OF THE INVENTION

The present invention is generally related to isometric exercise training within an infrared sauna, and the like, and more particularly related to several methods for isometric exercise training within an infrared sauna system and several infrared sauna systems specifically designed for use by one or more users performing, or being directed to perform, a sequence of isometric poses, thereby causing the users to receive the wellness benefits of both far infrared rays and isometric exercise training.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK.

Not applicable.

### BACKGROUND OF THE INVENTION

The present invention relates to isometric exercise training within an infrared sauna, and the like, and more particularly relates to several methods for isometric exercise training within an infrared sauna system and several infrared sauna systems specifically designed for use by one or more users performing, or being directed to perform, a sequence of isometric poses. By utilizing the herein disclosed methods and systems, a wellness or exercise facility can provide its users the wellness benefits of both far infrared rays and isometric exercise training in combination.

Existing technology provides for isometric training in standard room temperature conditions or outdoor air conditions. Existing technology also provides infrared saunas for exposing users to infrared rays, heating both the surrounding air and the user's skin molecules and thereby providing wellness benefits. But the two independent disciplines have never before been utilized in combination. A bit of the background of both infrared sauna usage and isometrics will be explained.

A sauna is a small room or building designed as a place to experience dry or heat sessions, or an establishment with one or more of these facilities. The steam and high heat make the sauna bathers perspire. A portable sauna is a sauna that is detached from other structures. Existing sauna technology would have to be purchased to fit inside a room, making it impossible to install a large sauna in a pre-built existing room. Alternatively, developers have built saunas into their new developments.

Infrared sauna technology is well known in the art. An infrared ray is divided into near infrared rays that have a wavelength from 0.76 to 1.5 microns, middle infrared rays that have a wavelength from 1.5 to 5.6 microns, and far infrared rays that have wavelengths from 5.6 to 1000 microns. Of these, the far infrared ray has a characteristic that may penetrate into human skin up to 40 mm, and resonate molecules that form human cells, thereby causing the molecules to generate heat by themselves.

An infrared sauna system utilizes far infrared rays as its heating source. This allows infrared sauna systems to provide wellness benefits to a user at temperatures in the range of 110 to 140 degrees Fahrenheit. By contrast, non-infrared sauna systems, such as traditional steam sauna systems that heat the sauna air, require temperatures in the range of 150 to 200 degrees Fahrenheit and thus are unsafe for certain classes of users such as children, the elderly, and individuals weak from illness.

Portable and/or collapsible infrared sauna systems have been developed, but they have been for use by a single person at a time and not for public or commercial use by groups of users. For example, U.S. Pat. No. 4,773,105 Toyoshima discloses a collapsible sauna box to be used as a home infrared sauna in a private home or an apartment. As is apparent in Toyoshima FIG. 1, the collapsible sauna is meant for the use of only one user at a time, and provides no room for the user to perform any type of movement, exercises, yoga positions, or isometrics. U.S. Pat. No. 7,120,353 Schaeffer et al. also discloses such a single user portable infrared sauna.

Another existing form of sauna which may be characterized as “portable” involves retrofitting an existing room, either in an immoveable structure or in a trailer or other moveable structure, with infrared emitter panels and a connected control device to create an infrared sauna system in any desired location. U.S. Pat. No. 6,745,411 Kjonaas discloses such a retrofitting-type portable sauna system. Kjonaas describes an objective of its disclosed invention as “provid[ing] a spa system that may be constructed within many enclosed areas including closets, rooms and corners of a home.” Kjonaas Col. 2 lines 60-63. But Kjonaas discloses a system for retrofitting infrared emitter panels directly to existing walls, utilizing the walls already present in the enclosed area. Kjonaas does not disclosure a method or system for building a smaller, multi-user infrared sauna enclosure within a larger enclosure.

Isometrics, or isometric exercises, are a type of strength training in which the angle of a user's joints and the length of the user's muscles do not change during contraction. In other words, isometrics are done in static position. This is in contrast to dynamic training exercises in which the user's body is put through a range of motion. For example, a user of isometrics presses his or her hands together in a prayer position as hard as he or she can for 10 seconds. This is an isometric pose. The user will feel tension in his or her chest and arms, yet the user's arms do not move at all during the isometric pose. In an isometric pose, or isometric position, like this the user's muscle fibers are activated but since there are equal forces against each other there is no movement. Isometric exercises are possibly thousands of years old (yoga and martial arts incorporate aspects of isometrics), but in the prior art have always been practiced in open air situations or in standard indoor areas, such as gyms, studios or other exercise facilities, at room temperature.

It would therefore be advantageous to combine the benefits of infrared sauna use with the benefits of isometric exercise training. Infrared saunas have not been traditionally used for training as they are usually built as small as possible in order to get infrared emitter panels close to the user(s). Larger infrared saunas have been developed but they rely on retrofitting existing rooms within structures, as with Kjonaas discussed above. These larger infrared saunas are not portable in that the entire structure is not portable—it relies on portable elements combined with existing structures. It would be advantageous to create a portable infrared sauna system specifically designed for use by a plurality of isometric exercise users.

The herein disclosed system and methods for isometric exercise training within an infrared sauna allows for advantageous combination on the known benefits of infrared sauna systems with the known benefits of isometric exercise training. The benefits of infrared sauna systems for a user are well known. So too are the benefits to a user of isometric exercise and isometric pose sequences. Both infrared sauna use and isometric exercise use are well known in the wellness industry and are standard practices in public and commercial spas, gyms, and other wellness facilities around the world. The combination of the two wellness regiments is heretofore unknown. It would be advantageous for a wellness facility (or exercise facility) to provide an exercise program combining infrared sauna use with isometric poses. It would also be advantageous to provide an infrared sauna system specifically designed for use by users performing, or being directed to perform, isometric poses routines.

### BRIEF DESCRIPTION OF THE SEVERAL VIEWS OF THE DRAWING

FIG. 1 illustrates a general overview of the herein disclosed methods for isometric exercise training within an infrared sauna in accordance with the present invention;

FIG. 2 illustrates an isometric view of an exemplary embodiment of the herein disclosed system for isometric exercise training within an infrared sauna;

FIG. 3A illustrates a top-down view of an exemplary embodiment of a floor and walls of the herein disclosed isometric exercise training within an infrared sauna in accordance with the present invention;

FIG. 3B illustrates a view of an exemplary embodiment of a first side wall of the herein disclosed isometric exercise training within an infrared sauna in accordance with the present invention;

FIG. 3C illustrates a view of an exemplary embodiment of a second side wall of the herein disclosed isometric exercise training within an infrared sauna in accordance with the present invention;

FIG. 3D illustrates a view of an exemplary embodiment of a back wall of the herein disclosed isometric exercise training within an infrared sauna in accordance with the present invention; and

FIG. 3E illustrates a view of an exemplary embodiment of a front wall of the herein disclosed isometric exercise training within an infrared sauna in accordance with the present invention.

### DETAILED DESCRIPTION OF THE INVENTION

The herein disclosed systems and methods for isometric exercise training within an infrared sauna system provide one or more users with the combined wellness benefits of infrared sauna use and isometric pose exercise training. A system is disclosed that utilizes infrared sauna technology in a novel arrangement optimized for use by users being directed to perform isometric pose sequences. Several methods are additionally disclosed that allow a public or commercial wellness facility (or exercise facility) to provide isometric pose exercise training combined with concurrent infrared sauna exposure. As will be explained, various elements of both the herein disclosed system and the herein disclosed methods may be included at a facility's discretion to tailor their users' wellness experience. But the herein disclosed methods must comprise at a minimum: (1) positioning one or more users within an infrared sauna system (3) exposing the one or more users to a plurality of infrared rays, and (2) directing the one or more users through a plurality of isometric poses while the one or more users are exposed to the plurality of infrared rays. The herein disclosed system(s) must comprise at a minimum: one or more infrared emitter panels, space for one or more users to perform a plurality of isometric poses, and a wall (or rigid vertical surface) substantially devoid of infrared emitter panels providing a safe surface for the one or more users to interact and/or balance against while performing the plurality of isometric poses. In an alternative embodiment the wall substantially devoid of infrared emitter panels may be replaced by one or more bars, or other rigid structures or surfaces, anchored within the isometric pose space and functionally providing a safe surface for the one or more users to interact and/or balance against while performing the plurality of isometric poses.

An exemplary and preferred embodiment of the herein disclosed method for isometric exercise training within an infrared sauna comprises the steps of: positioning one or more users within an infrared sauna system having a display screen for displaying video to the one or more users, a first side wall, a second side wall, a back wall, and a front wall, wherein the first side wall supports the display screen, one or more infrared emitter panels, and one or more mirrors, the second side wall is substantially devoid of infrared emitter panels, the back wall supports a plurality of infrared emitter panels, and the front wall has a glass sliding door and supports one or more infrared emitter panels; exposing the one or more users to a plurality of infrared rays; controlling a temperature of the infrared sauna system; controlling an exercise time for the one or more users; and directing the one or more users through a plurality of isometric poses by displaying a pre-recorded video on the display screen, the pre-recorded video including an isometric pose sequence having the plurality of isometric poses displayed in a predetermined sequential order.

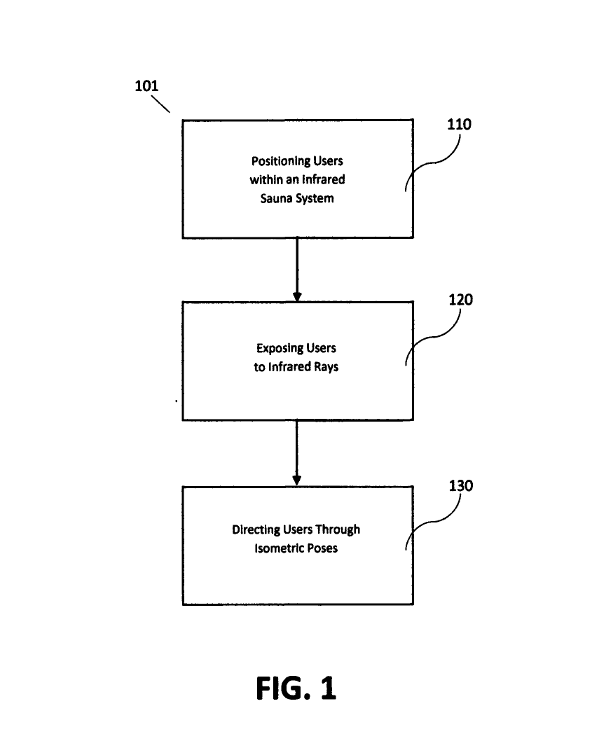

FIG. 1 illustrates an exemplary embodiment of a herein disclosed method 101 for isometric exercise training within an infrared sauna. FIG. 1 shows the minimal component steps comprising the herein disclosed method. Step 110 includes positioning one or more users within an infrared sauna system. A preferred embodiment involves three users being simultaneously positioned upon three exercise mats in the isometric pose space created by the walls of an infrared sauna system. One user, however, may utilize there herein disclosed method. Or alternatively, several users may utilize this method for isometric exercise training within an infrared sauna. The infrared sauna system utilized in the herein disclosed method can be any infrared sauna system known in the art. This application will also disclose an infrared sauna system specifically designed and arranged for use with the herein disclosed method for isometric exercise training within the infrared sauna. But the later described system is not meant to be a limitation on the infrared sauna system utilized in step 110 of FIG. 1.

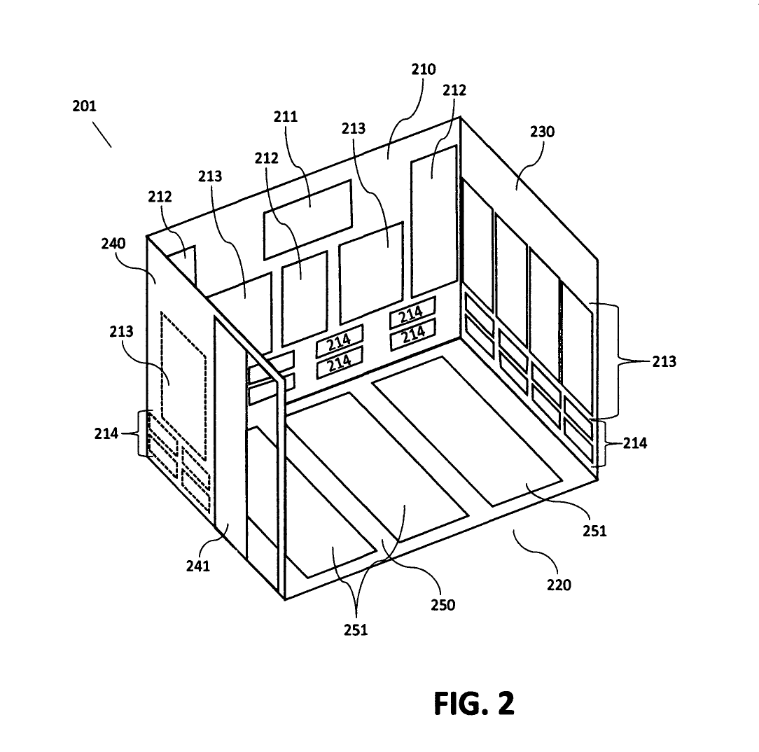

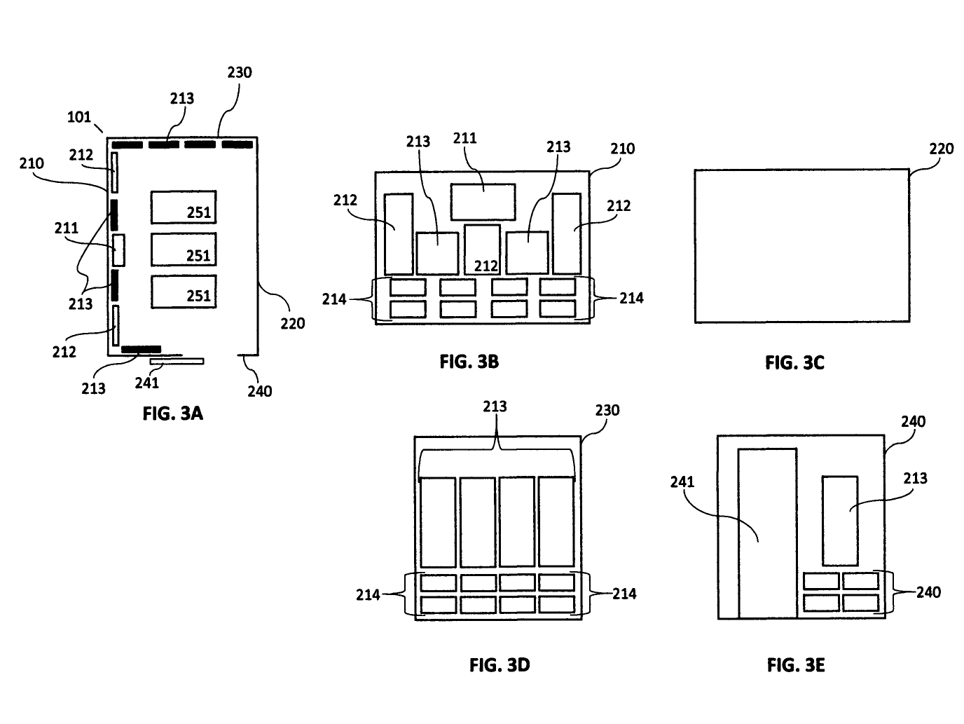

In an exemplary embodiment of the herein disclosed method, the infrared sauna system may include a first wall, a second wall, a back wall, a floor, and a ceiling. The first wall may support a display screen for displaying video directing the one or more users through an isometric pose sequence. The display screen can be any sort of display screen known in the art. It may, for example, be a television (standard definition, high-definition, 4k, or any other television known in the art) or a computer monitor. The video being displayed on the display screen can be a pre-recorded video in any format known in the art, or it may be a live-feed or live stream from another location either within the exercise facility or located elsewhere. For example, the video may be a pre-recorded session with a certified or experienced isometric instructor instructing the users to follow a specific sequence of isometric poses. In another embodiment, an exercise facility may have a live-stream playing on the display screen, also instructing the users to follow a specific sequence of isometric poses. The first wall may also support one or more infrared emitter panels. Any sort of infrared emitter panel known in the art may be utilized, as explained below. And the first wall may also support one or more mirrors. The mirrors are of any type commonly utilized in exercise facilities to allow users to see themselves exercising and thereby optimize their exercise form. The second wall is substantially devoid of infrared emitter panels so that users may lean against or otherwise brace themselves using the second wall while they perform isometric poses. The second wall may, in certain embodiments, support one or more infrared emitter panels. But there must be substantial space on the second wall not dedicated to supporting infrared emitter panels so as to allow users to touch the second wall without danger or harm, or fear of danger or harm, from heat and infrared rays emitted from infrared emitter panels. The back wall may support one or more infrared emitter panels. And the front wall may include a door, which may be a sliding glass door or any other type of door known in the art, and one or more infrared emitter panels. An exemplary embodiment of such an infrared sauna system appropriately designed for use with the herein disclosed method is illustrated in FIG. 2 and FIGS. 3A through 3E.

Continuing with FIG. 1, step 120 includes exposing the one or more users to a plurality of infrared rays. As described above in the Background section of this specification, infrared sauna systems provide wellness benefits to users by exposing users to far infrared rays. The herein disclosed methods involve exposing the one or more users to a plurality of infrared rays emitted from the infrared sauna system's one or more infrared emitter panels. Many types and brands of infrared emitter panels (also referred to as infrared emitters) are known in the art. For example, there are ceramic tube (or rod) emitters, carbon emitters, concave ceramic emitters, and others. Any such emitter may be utilized both with the disclosed method(s) for isometric exercise training within an infrared sauna, and with the disclosed system(s) for isometric exercise training within an infrared sauna. In a preferred embodiment, the infrared sauna system utilized in step 110 includes several infrared emitter panels supported on the various walls of the infrared sauna system, and all or some of the infrared emitter panels (emitters) expose the users to infrared rays.

In a preferred embodiment of the herein disclosed methods, step 120 includes controlling a temperature of the infrared sauna system. Control devices for infrared saunas are known in the art, and may be utilized to control the infrared rays emitted from the one or more infrared emitter panels, and thereby control the air temperature of the infrared sauna system utilized in disclosed method 101.

Step 130 of FIG. 1 includes directing the one or more users through a plurality of isometric poses. The directing may be accomplished via the display screen described above. The display screen may be included in the infrared sauna system, and may be supported by the first wall of the infrared sauna system. For example, an isometrics instructor may pre-record a video demonstration of a plurality of isometric poses. This pre-recorded video may be displayed on the display screen and thereby direct the users through the plurality of isometric poses. But the directing of step 130 may alternatively be accomplished through live instruction. For example, an isometrics instructor (which may be an employee of the exercise facility utilizing the herein disclosed method for isometric exercise training within an infrared sauna) may also be positioned, like a user, within the infrared sauna system. The directing, whether by the display screen or by a live instructor, of step 130 involves leading the one or more users through a plurality of isometric poses. The isometric poses may be performed in a predetermined sequence (a predetermined sequential order), or may be performed spontaneously at the discretion of either the instructor or the various users.

An example of a predetermined sequential order of isometric poses includes beginning by performing a lower body flush comprising one or more lower body focused isometric poses, then performing an upper body flush comprising one or more upper body focused isometric poses, then performing a core flush comprising one or more core focused isometric poses, and finally performing a landing phase comprising one or more stretches and a relaxation (or meditation) moment. Alternatively, the order of the flushes may be altered in any possible permutations without changes the effect; all such permutations are included herein.

Lower body focused isometric poses can include: wall sit, wall calves standing plank, squat, reverse plank (focus on hamstrings), reverse plank (with calf raise), etc. Upper body focused isometric poses can include: push-up position plank, iso-chest compress, bent row (back isolation), bent row (triceps extension), half-extension bicep curl, etc. Core focused isometric poses can include: seated twist (right and left), upright lunge (right forward and left forward), hand down lunge (right hand and left hand), yoga style sit-ups, etc.

Step 130 may additionally include controlling an exercise time for the one or more users. If a video is used for directing, the video may be of a predetermined time length in order to optimize the isometric pose sequence. If a live instructor is used for directing, the instructor may keep track of the isometric pose sequence time. A control device may also include an ability to control, or set, an exercise time for the one or more users. For example, the control device may be set to turn off the one or more infrared emitter panels, or adjust the temperature setting of the infrared emitter panels, after a certain exercise time has elapsed.

The herein disclosed combination of infrared sauna usage with isometric pose training also includes a system for isometric exercise training within an infrared sauna. An infrared sauna system for performing isometric poses is disclosed comprising: a first side wall supporting a display screen, a plurality of infrared emitter panels, and one or more mirrors, wherein the display screen displaying an isometric pose video includes an isometric pose sequence for directing a plurality of users through the isometric pose sequence; a second side wall substantially devoid of infrared emitter panels; a back wall supporting a plurality of infrared emitter panels; a front wall including a door and supporting one or more infrared emitter panels; an isometric pose space for the plurality of users to perform the isometric pose sequence and including a plurality of workout mats; and a control device for controlling a temperature of the infrared sauna system and a session time of the infrared sauna system.

A preferred embodiment of such a system is illustrated in isometric view in FIG. 2. System for isometric exercise training within an infrared sauna 201 may include a first side wall 210. First side wall 210 may support display screen 211, one or more mirrors 212, one or more large infrared emitter panels 213, and one or more small infrared emitter panels 214. Display screen 211 may be of any sort of display screen known in the art, and first side wall 210 may support more than one display screen. For example, each of the one or more users may have his or her own display screen 211 within system 201. Mirrors 212 may be of any sort commonly utilized in exercise facilities. Ideally, mirrors 212 are large enough for a user to view his or her entire body while performing, or being directed through, a sequence of isometric poses. First wall 210 may support one mirror 212 for each of the one or more users. Large emitter panels 213 may be any type of infrared emitter known in the art. In a preferred embodiment, large emitter panels 213 are each approximately 620 to 640 square inches. Small emitter panels 214 may also be any type of infrared emitter known in the art. In a preferred embodiment, small emitter panels 214 are each approximately 90 square inches. The exemplary embodiment illustrated in FIG. 2 shows two large emitter panels 213 and eight small emitter panels 214 supported by first side wall 210. In the preferred embodiment, first side wall 210 is approximately 9 feet in length.

As shown in FIG. 2, system for isometric exercise training within an infrared sauna 201 may include a second side wall 220. Second side wall 220 is not affirmatively illustrated in FIG. 2, in order to allow the reader to view inside system 201, but is located directly opposite first side wall 210 and is labeled as 220. Second side wall 220 is substantially devoid of emitter panels, in order to allow the one or more users to utilize second side wall 220 in their directed performance of an isometric pose sequence. The second wall may, in certain embodiments, support one or more infrared emitter panels. But there must be substantial space on the second wall not dedicated to supporting infrared emitter panels so as to allow users to touch the second wall without danger or harm, or fear of danger or harm, from heat and infrared rays emitted from infrared emitter panels. In a preferred embodiment, second wall 240 is approximately 9 feet in length.

The disclosed system for system for isometric exercise training within an infrared sauna 201 may include a back wall 230. Back wall 230 may support one or more infrared emitter panels, which may include a mix of large emitter panels 213 and small emitter panels 214. In a preferred embodiment, back wall 230 is approximately 7 feet in width. The system 201 may additionally include a front wall 240. Front wall 240 may support one or more infrared emitter panels, which again may be a mix of large emitter panels 213 and small emitter panels 214. Alternatively, front wall 240 may support a larger emitter panel, which may be approximately 960 square inches. Front wall 240 may additionally include a door 241. Door 241 may be any type of door known in the art, either sliding along front wall 240 to open and close or swinging open and close from one or more hinges supported by front wall 240. In a preferred embodiment, door 241 is a sliding door formed substantially from glass or a glass-like (translucent) material such as acrylic plastic sheet (Plexiglass) or the like. In the preferred embodiment, front wall 240 is also 7 feet in width.

The disclosed system for isometric exercise training within an infrared sauna 201 illustrated in FIG. 2 may also include floor 250. Floor 250 may include one or more workout mats 251 for the one or more users. The workout mats 251 may be loose and moveable, or they may be built in, or attached to, floor 250. Workout mats 251 may be of any type known in the art and commonly utilized in exercise facilities. System 201 may also include a ceiling, which is not illustrated in FIG. 2 so as to allow the reader to view the inside of system 201.

The four walls (first side wall, second side wall, back wall, and front wall) and the floor of the system for isometric exercise training within an infrared sauna 201 create an open space which may be referred to as an isometric pose space. The isometric pose space may be utilized by the one or more users to perform isometric pose sequence(s). One or more workout mats (or exercise mats) may be positioned within the isometric pose space.

The herein disclosed system for isometric exercise training within an infrared sauna may additionally include a control device for controlling a temperature of the system and/or an exercise time of the system. Many control devices for controlling infrared saunas are known in the art and any such control device may be utilized with this system. The control device may directly control the one or more infrared emitter panels and thereby indirectly control the temperature and/or the exercise time of the system.

FIG. 3A illustrates a top-down view of an exemplary embodiment of a floor and walls of the herein disclosed isometric exercise training within an infrared sauna in accordance with the present invention. System for isometric exercise training within an infrared sauna 201 may include: a first wall 210 having a display screen 211, one or more large infrared emitter panels 213, and one or more mirrors 212; a second wall 220 substantially devoid of infrared emitter panels; a back wall 230 supporting one or more large infrared emitter panels 213; a front wall 240 having a door 241 and supporting one or more large infrared emitter panels 213; and a floor 250 having one or more workout mats 251.

FIG. 3B illustrates a view of an exemplary embodiment of a first side wall of the herein disclosed isometric exercise training within an infrared sauna in accordance with the present invention. System for isometric exercise training within an infrared sauna 201 may include a first side wall 210. First side wall 210 may support display screen 211, one or more mirrors 212, one or more large infrared emitter panels 213, and one or more small infrared emitter panels 214. In the preferred embodiment, first side wall 210 is approximately 9 feet in length and approximately 7 feet in height.

FIG. 3C illustrates a view of an exemplary embodiment of a second side wall of the herein disclosed isometric exercise training within an infrared sauna in accordance with the present invention. System for isometric exercise training within an infrared sauna 201 may include a second side wall 220. Second side wall 220 is substantially devoid of emitter panels, in order to allow the one or more users to utilize second side wall 220 in their directed performance of an isometric pose sequence. In a preferred embodiment, second wall 220 is approximately 9 feet in length and approximately 7 feet in height.

FIG. 3D illustrates a view of an exemplary embodiment of a back wall of the herein disclosed isometric exercise training within an infrared sauna in accordance with the present invention. System for isometric exercise training within an infrared sauna 201 may include a back wall 230. Back wall 230 may support one or more infrared emitter panels, which may include a mix of large emitter panels 213 and small emitter panels 214. In a preferred embodiment, back wall 230 supports four large infrared emitter panels 213 and eight small emitter panels 214. In the preferred embodiment, back wall 230 is approximately 7 feet in width and approximately 7 feet in height.

FIG. 3E illustrates a view of an exemplary embodiment of a front wall of the herein disclosed isometric exercise training within an infrared sauna in accordance with the present invention. System for isometric exercise training within an infrared sauna 201 may include a front wall 240. Front wall 240 may support one or more infrared emitter panels, which again may be a mix of large emitter panels 213 and small emitter panels 214. In a preferred embodiment, front wall 240 may support a larger emitter panel, which may be approximately 960 square inches, and four small emitter panels 214. Front wall 240 may additionally include a door 241. In a preferred embodiment, door 241 is a sliding door that slides open and closed along the plain of front wall 240. In the preferred embodiment, front wall 240 is approximately 7 feet in width and approximately 7 feet in height.

Throughout this specification the various components, or elements, comprising the system and methods for isometric exercise training within an infrared sauna are described as being supported by the various walls of the system. This refers to the fact that components, such as infrared emitter panels, may be hung from or otherwise rigidly connected to one or more walls of the system. It is to be understood that it may be possible to support, or otherwise connect, each of these elements to the floor and/or ceiling of the system while still placing them in close proximity to one or more walls. Such an arrangement is not functionally different or distinguishable from those components being supported by walls and is therefore intended to be included within the herein disclosed and described system and methods for isometric exercise training within an infrared sauna.

Finally, it should be noted that while throughout the specification the various elements supported by the walls of the system for isometric exercise training within an infrared sauna are supported (or positioned) consistently, it also may be possible to configure the herein disclosed system in an alternative but substantially similar way without effecting the benefits provided to a user of the disclosed combination of isometric poses with infrared sauna usage. For example, the components (or elements) supported by the first side wall (display device 211, mirrors 212, large infrared emitters 213, and small infrared emitters 214) may instead be supported by the back wall. In that case, the elements supported by the back wall (large infrared emitters 213 and small infrared emitters 214) may instead be supported by the first side wall. In this way, the wall of system 201 are interchangeable, and all such permutations are intended to be included within this specification.

While the present invention has been illustrated and described herein in terms of a preferred embodiment and several alternatives, it is to be understood that the techniques described herein can have a multitude of additional uses and applications. Accordingly, the invention should not be limited to just the particular description and various drawing figures contained in this specification that merely illustrate a preferred embodiment and application of the principles of the invention.

What is claimed is:

1. A method for exercising, comprising the steps of:
positioning one or more users within an infrared sauna system;
exposing the one or more users to a plurality of infrared rays; and
directing the one or more users through a plurality of isometric poses.

2. The method as recited in claim 1, further comprising the step of controlling a temperature of the infrared sauna system.

3. The method as recited in claim 1, further comprising the step of controlling an exercise time for the one or more users.

4. The method as recited in claim 1, further comprising the steps of:
controlling a temperature of the infrared sauna system; and
controlling an exercise time for the one or more users.

5. The method as recited in claim 1, wherein the infrared sauna system includes a display screen for displaying a video to the one or more users, and wherein the step of directing includes displaying the video on the display screen.

6. The method as recited in claim 5, wherein the video includes a live instructional feed having an isometric pose sequence wherein the isometric pose sequence includes a plurality of isometric poses displayed in a sequential order.

7. The method as recited in claim 5, wherein the video includes a pre-recorded video, wherein the pre-recorded video includes an isometric pose sequence having a plurality of isometric poses displayed in a sequential order.

8. The method as recited in claim 7, wherein the sequential order includes a lower body flush including one or more lower body focused isometric poses, then an upper body flush including one or more upper body focused isometric poses, then a core flush including one or more core focused isometric poses, then a landing phase including one or more stretches and a relaxation period.

9. The method as recited in claim 7, wherein the infrared sauna system includes a first side wall and a second side wall, wherein the first side wall supports the display screen, one or more infrared emitter panels, and one or more mirrors, and wherein the second side wall is substantially devoid of infrared emitter panels.

10. The method as recited in claim 9, wherein the infrared sauna system further includes a back wall and a front wall, wherein the back wall supports a plurality of infrared emitter panels, and wherein the front wall supports one or more infrared emitter panels and includes a door.

11. The method as recited in claim 10, wherein the door is formed substantially of glass and wherein the door slides along the front wall to open and shut.

12. The method as recited in claim 1, wherein the infrared sauna system includes a first side wall and a second side wall, wherein the first side wall supports the display screen, one or more infrared emitter panels, and one or more mirrors, and wherein the second side wall is substantially devoid of infrared emitter panels.

13. The method as recited in claim 12, wherein the infrared sauna system further includes a back wall and a front wall, wherein the back wall supports a plurality of infrared emitter panels, and wherein the front wall supports one or more infrared emitter panels and includes a door.

14. The method as recited in claim 13, wherein the door is formed substantially of glass and wherein the door slides along the front wall to open or shut.

15. The method as recited in claim 13, wherein the infrared sauna system provides isometric pose space for three users, and wherein the infrared sauna system further includes three workout mats.

16. A method for exercising, comprising the steps of:
positioning one or more users within an infrared sauna system including a display screen for displaying video to the one or more users, a first side wall, a second side wall, a back wall, and a front wall, wherein the first side wall supports the display screen, one or more infrared emitter panels, and one or more mirrors, the second side wall is substantially devoid of infrared emitter panels, the back wall supports a plurality of infrared emitter panels, and the front wall supports one or more infrared emitter panels and includes a door;
exposing the one or more users to a plurality of infrared rays;
controlling a temperature of the infrared sauna system;
controlling an exercise time for the one or more users; and
directing the one or more users through a plurality of isometric poses by displaying a pre-recorded video on the display screen, the pre-recorded video including an isometric pose sequence having the plurality of isometric poses displayed in a predetermined sequential order.

17. The method as recited in claim 16, wherein the predetermined sequential order includes a lower body flush including one or more lower body focused isometric poses, then an upper body flush including one or more upper body focused isometric poses, then a core flush including one or more core focused isometric poses, then a landing phase including one or more stretches and a relaxation period.

18. An infrared sauna system for performing isometric poses, comprising:
a first side wall supporting a display screen, a plurality of infrared emitter panels, and one or more mirrors, the display screen displaying an isometric pose video including an isometric pose sequence for directing a plurality of users through the isometric pose sequence;
a second side wall substantially devoid of infrared emitter panels;
a back wall supporting a plurality of infrared emitter panels;
a front wall including a door and supporting one or more infrared emitter panels;
an isometric pose space for the plurality of users to perform the isometric pose sequence and including a plurality of workout mats; and
a control device for controlling a temperature of the infrared sauna system and a session time of the infrared sauna system.

19. The infrared sauna system for performing isometric poses as recited in claim 18, wherein:
the first side wall is approximately 9 feet in length;
the second side wall is approximately 9 feet in length;
the back wall is approximately 7 feet in width;
the front wall is approximately 7 feet in width;
the door is approximately 38 inches in width; and
the isometric pose space is approximately 63 square feet in area.

20. The infrared sauna system for performing isometric poses as recited in claim 19, wherein the first side wall plurality of infrared emitter screens includes two large emitter panels of approximately 620 square inches each and eight small infrared emitter panels of approximately 90 square inches each, wherein the back wall plurality of infrared emitter panels includes four large infrared emitter panels of approximately 640 square inches each and eight small infrared emitter panels of approximately 90 square inches each, and wherein the front wall one or more infrared emitter panels includes one large infrared emitter panel of approximately 960 square inches and four small infrared emitter panels of approximately 90 square inches each.
